(19) United States
(12) Patent Application Publication
(10) Pub. No.: US 2013/0297613 A1
(43) Pub. Date: Nov. 7, 2013

(54) INDEXING BASED ON KEY RANGES

(71) Applicant: Cui Yu, Marlboro, NJ (US)

(72) Inventor: Cui Yu, Marlboro, NJ (US)

(73) Assignee: MONMOUTH UNIVERSITY, West Long Branch, NJ (US)

(21) Appl. No.: 13/464,274

(22) Filed: May 4, 2012

(51) Int. Cl. G06F 17/30

(52) U.S. Cl. 707/741; 707/E17.002; 707/E17.014

(57) ABSTRACT

The present invention is a fast indexing technique that builds an indexing structure based on multi-level key ranges typically for large data storage systems. The invention is explained based on the B⁺-tree. It is designed to reside in main memory. Point searches and range searches are helped by early termination of searches for non-existent data. Range searches can be processed depth-first or breath-first. One group of multiple searches can be processed with one pass on the indexing structure to minimize total cost. Implementation options and strategies are explained to show the flexibility of this invention for easy adaption and high efficiency. Each branch of any level has exact and clear key boundaries, so that it is very easy to build or cache partial index for various purposes. The inventive indexing structure can be tuned to speed up queries directed at popular ranges of index or index ranges of particular interest to the user.

### FIELD OF THE INVENTION

The present invention relates to an indexing method based on key ranges and more particularly to a fast and flexible indexing structure which can exploit tree structure and resides in main memory.

### BACKGROUND OF THE INVENTION

As main memory becomes cheaper, more and more databases (datasets) will exist partially or entirely in the RAM of a computer or server system. In many cases, this trend will improve performance greatly. However, RAM-based databases are not appropriate or possible for all situations: (1) there are still many space-heavy applications where large disks are necessary, not to mention legacy systems; (2) there are applications using large volumes of data that are stored on multiple computers/servers; (3) there are applications that rely on remote data access over networks; (4) portable devices are often data fed but have limited storage space; and (5) there are many complex queries that rely on multiple basic searches.

Two basic tree data structures are ISAM (Indexed Sequential Access Method) and B⁺-tree. ISAM is a straightforward multi-level indexing method, which organizes static data sets based on sortable keys. The B⁺-tree is a widely used dynamic indexing structure which also organizes objects based on sortable keys. These tree structures are made up of internal nodes that guide a search along the shortest possible route to a leaf node, where records or pointers to actual records are stored. The keys in the leaf node level appear in sorted fashion. A lot of practical indexing strategies and advanced indexing techniques use ISAM or B⁺-tree as supporting index structures. While these two indexing structures support point and range queries well, they have their own limits.

A method is desired that is designed for but not limited to applications that can benefit from indexing based on sortable keys, such as (but not limited to) ISAM, B⁺-tree, their variants, and indexing techniques built with base indexing structures like ISAM or B⁺-tree, including their variants. A method is desired that will give more flexibility, such as early termination instead of only strict level-by-level guiding to a leaf node for every single search. A method is desired that will create personalized “indexing” for individual users and different groups of users. A method is desired that will benefit databases that can't reside in main memory, and those that require multiple disk or external or remote IO operations for a single query. A method is desired that can improve the system performance by allowing queries to execute faster while maintaining an easily updateable internal structure.

### BRIEF SUMMARY OF THE INVENTION

The invention describes a new indexing method that builds multi-level key ranges to support point and range queries. The index resides in main memory. It works for any plurality of objects that can be sorted based on keys. It can gracefully make use of and/or work with practical tree structures such as ISAM and B⁺-tree. It is faster and more flexible than the commonly used indexing methods such as ISAM and B⁺-tree.

Three embodiments are disclosed, particularly based on the B⁺-tree. The same ideas work for ISAM straightforwardly and can be extended to any sortable data lists. Leaf nodes in this article refer to the leaf nodes of the B⁺-tree, ISAM, or just plain lists of sorted keys and (addresses of) objects.

The first embodiment is the FB⁺-tree, which is designed to create indexing of this invention referring to B⁺-tree, to fit in main memory, and to execute basic searches fast. A search for non-existing data will terminate as soon as the target key is found to not fit within any level of key boundaries. Only if the target object is present in a key range of a cache node will the search proceed to the next level. Its range searches don't have to follow the leaf-node-level link of the B⁺-tree to get sibling pointers. Multiple point searches and/or range searches can be processed with “one pass” on the FB⁺-tree, checking all and only the relevant key ranges, to get a final matched or merged list of leaf node addresses for a complex query.

A second embodiment is the F²B⁺-tree, where subset(s) of key ranges are specifically selected to create a partial FB⁺-tree. It could be personalized for an individual user, custom-fit for a group of users, pre-designed for a specific kind of application, prepared for one particular data cluster, or for other reasons. It uses less memory space than the FB⁺-tree because of its focused indexing on subsets of objects. Overall system performance will be greatly improved when the idea is used wisely.

A third embodiment is the F³B⁺-tree. It determines which leaf nodes of the B⁺-tree are used most often in searches. Searches are first conducted in “popularity cache nodes”, where shortcuts to popular leaf nodes are stored. Such shortcuts can greatly speed up the search process. If the object being sought is not in the range of the popularity cache nodes, the search is continued following the regular FB⁺-tree cache nodes or, if necessary, B⁺-tree nodes.

### BRIEF DESCRIPTION OF THE DRAWING

FIG. 1 is a B⁺-tree of order 4.

FIG. 2 is an internal node of a B⁺-tree of order 7.

FIG. 3 shows the use of search keys to determine child. Sample searches for keys 124, 37, and 1.

FIG. 4 shows a search through a B⁺-tree for key 29.

FIG. 5 shows the insertion of key 30 into a leaf node.

FIG. 6 shows the deletion of key 30 from a leaf node.

FIG. 7 is a visual comparison of a B⁺-tree and the FB⁺-tree of the present invention.

FIG. 8 shows the FB⁺-tree Structure Options.

FIG. 9 is a search on the FB⁺-tree that leads to a leaf node.

FIG. 10 is a search on the FB⁺-tree that ends before reaching a leaf node.

FIG. 11 is a first example of a range search on the FB⁺-tree.

FIG. 12 is a second example of a range search on FB⁺-tree.

FIG. 13 is a third example of a range search on FB⁺-tree.

FIG. 14 is an example of a complex query with multiple range searches on FB⁺-tree.

FIG. 15 shows the FB+-tree one-pass multi-range search algorithm.

FIG. 16 shows the FB⁺-tree cache creation algorithm.

FIG. 17 shows the FB⁺-tree branch boundary update algorithm.

FIG. 18 shows two F²B⁺-tree examples.

FIG. 19 is a F³B⁺-tree example.

FIG. 20 shows the structure of Popularity Cache Node.

FIG. 21 shows a Buffer Pool vs. a Popularity Table.

FIG. 22 shows the F³B⁺-tree cache reorganization algorithm.

FIG. 23 is an example of caching popular leaf-node addresses for a B⁺-tree.

FIG. 24 shows average I/O comparison under a first condition, and

FIG. 25 shows average I/O comparison under a second condition.

### DETAILED DESCRIPTION OF THE INVENTION

A new database indexing structure based on multi-level key ranges is provided with the present invention. It can work favorably for any large number of objects that are sortable based on indexing keys. It can be easily created and works well with ISAM or the B⁺-tree. In order to better understand the present invention, we will first describe the standard B⁺-tree, which we use to show how this invention can work with it.

### B⁺-Tree Structure

The B⁺-tree is a multi-way search tree, meaning that each node in the tree can have many keys and many children. This is in contrast to something like a binary tree, where the number of children allowed per node is limited to two by the structure itself. Every B⁺-tree has a characteristic called the order or branching factor b that determines the number of keys and children any one internal node can have. If b is the order of the tree and in is the actual number of children of a particular node, then ┌b/2┐≦m≦b. This applies to all internal nodes in the tree except for the root, which may have fewer children −2 at the minimum. All leaf nodes are linked together, and all the keys in the leaf node level are sorted. FIG. 1 shows a B⁺-tree of order 4.

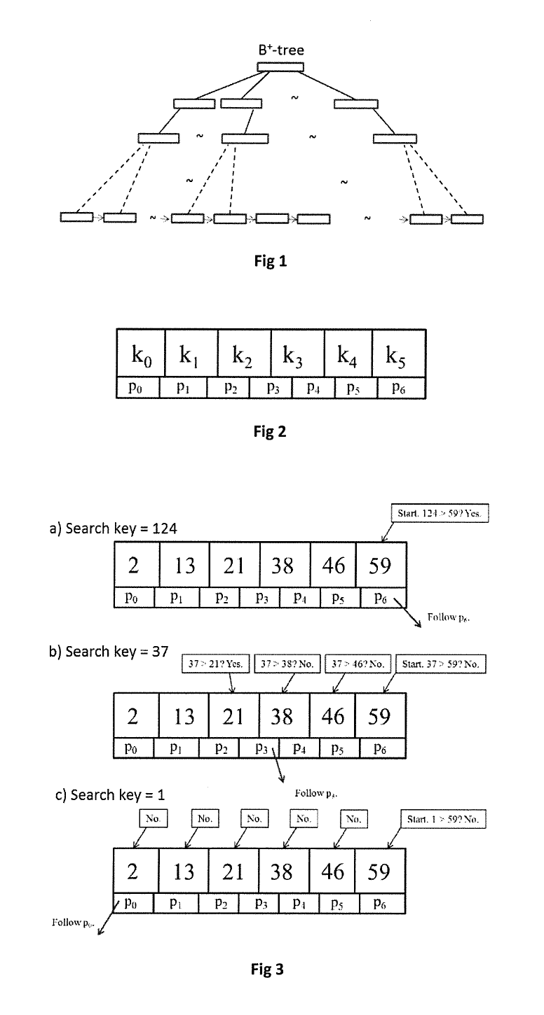

The order of the B⁺-tree also determines the number of keys per node, which is simply one less than the number of children, or m-1. A graphical representation of an internal node in a B⁺-tree of order 7 is shown in FIG. 2. In this figure, kᵢ is the i-th key in the node and pᵢ is a pointer to the i-th child. The leaf nodes are laid out in a way similar to the internal nodes of the tree, the main difference being that the pointers in the leaf nodes point to actual data records instead of child nodes. Sometimes the actual records can be in the leaf nodes. In such cases, pointers are not needed.

The leaves of the B⁺-tree have two other important differences from other nodes in the tree. For one, the keys in the leaves are actual keys of the records in the database, whereas the keys in the rest of the tree are just there to direct searches. The other difference is that leaves are connected sequentially as a linked list; internal nodes are not. These connections exist to make it easier to retrieve a range of records. To create this list, an extra pointer per leaf node is required.

### B⁺-Tree Search

The search algorithm is what enables the B⁺-tree to find records in the database. The algorithm is given a key to look for, and it returns either the record associated with that key, or an indication that it could not find the specified key if it does not exist.

The search begins at the root node. The search key is compared to each key in the root node. Because the keys are sorted, a more efficient searching technique like binary search can be used within the node. The linear search is described here since it is easier to illustrate. If at any point it is found that the search key is greater than or equal to the current key in the root node, then the child corresponding to that key is visited next. If each key in the root node is checked and the search key is less than all of them, then the very first child of the root node is visited next. A few examples are shown in FIG. 3.

This process of finding the right child node and visiting it is essentially narrowing down the possible keys at each step. The process continues until the leaf level is reached.

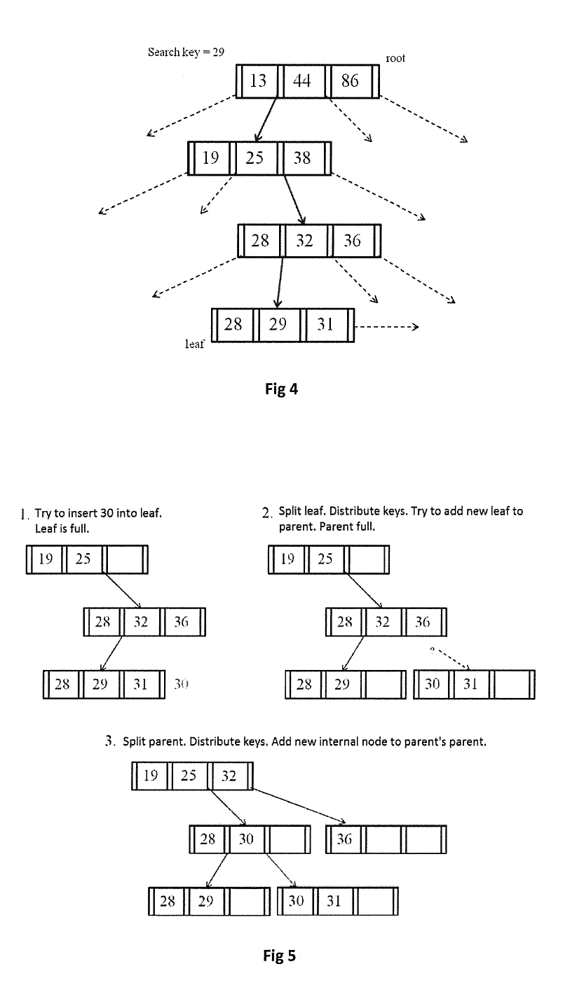

At the leaf level, the chosen leaf node is scanned for a matching key. If a match is found, its corresponding record is returned. If not, the key does not exist in the database. A complete search is illustrated in FIG. 4.

### Inserting a Key

When a new record is inserted into the database, the index must be updated to reflect this. The B⁺-tree is built to maintain its sorted structure even as new keys are added to it. When inserting a new key into the B⁺-tree, the first step is to perform a search, using the new key as the search key. This will locate the leaf node where the new key is to be placed. At this point, there are two possible scenarios: either there is room in the leaf to accommodate a new key, or the leaf is already full. In the event that the leaf has room, the proper position for the new key is determined and it is inserted in sorted order.

If the leaf does not have enough room for the new key, the leaf has to split into two leaves. When a split occurs, a new leaf node is created. The new key is added to the collection of keys in the old leaf node, and this sequence of keys is split in half with the first half going to the old leaf and the second half being placed in the new leaf. Now the parent node has to be told about the new leaf. The parent node will have to have a new key and pointer to refer to it. Here, again the parent can either hold a new pointer and key or it cannot. If the parent can hold the new key and pointer, the first key in the new leaf is copied up to the parent node maintaining sorted order and a new pointer is added to the leaf. If the parent cannot hold the new key and pointer, the parent itself will need to split. The split works the same way on internal nodes as it does on leaf nodes, except the key that gets sent up to the next parent is actually moved, not copied. Splitting continues up the tree until a parent node is able to accommodate a new key and a new pointer. If the split makes it all the way up to the root, and the root is full, then the root splits and a new root is created. As was the case before, the first key of the second half of the collection of split keys moves up to the parent, in this case the new, empty root. The height of the tree increases by one. This process is illustrated in FIG. 5.

### Deleting A Key

Deleting a key is basically the opposite of adding a key, and the algorithm for deleting a key from a B⁺-tree looks very much like the “opposite” of the insertion algorithm. The delete algorithm begins with a search for the leaf where the target key resides. At this point, there are two possible cases: the leaf is either at or above its minimum number of keys. If the leaf has more than the minimum number of keys, it is safe to simply scan for the target key and remove it.

If the leaf has the minimum number of keys, then a key from one of the leafs immediate siblings, a leaf to the left or right, will be “borrowed” to fill the gap created by the deletion. Sorted order must be maintained when borrowing from the leaf, and it is possible that a key in the parent node must be updated.

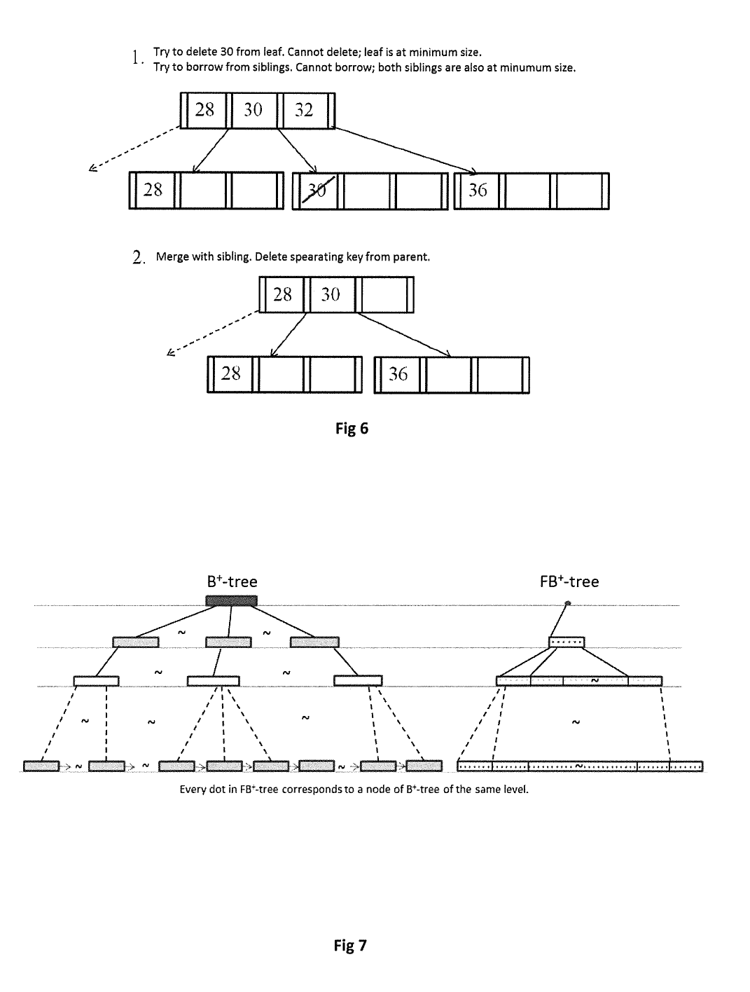

When both of the leafs siblings are also at the minimum number of keys, borrowing fails. In this case, the leaf will have to be merged with one of its siblings, combining both leaves' entries into one node and effectively removing one node from the tree. When a merge occurs, the parent node will lose one key since there is one less leaf to point to. If the parent node is at its minimum number of keys then it would also have to merge. This merge could propagate all the way up the tree to the root. If so, the tree will decrease in height by one. FIG. 6 shows an example of deletion.

### The FB⁺-Tree of the Present Invention

The FB⁺-tree is a light indexing structure that can be easily built by referring to a B⁺-tree to obtain multi-level key ranges. It resides in main memory. FIG. 7 illustrates the relationship between the B⁺-tree and FB⁺-tree in general. The FB⁺-tree consists of data structures called cache entries. In FIG. 7, each cache entry is illustrated as a dot. Each cache entry has a pointer to its next level cache node (a data structure that holds cache entries), or a B⁺-tree leaf node if at the bottom of the cache. Each cache entry represents and corresponds to a root node of a B⁺-tree branch.

During search operations, the FB⁺-tree plays the similar role as the internal levels of the B⁺-tree; however it provides special features that the B⁺-tree can't provide, such as exact and clear key boundaries of any branch, early termination of searches, various ways of range search processing, and minimizing IO cost of group searches. A stand-alone in-memory FB⁺-tree for search operations definitely eases the burden on a disk-based B⁺-tree.

### Structure of the FB⁺-Tree

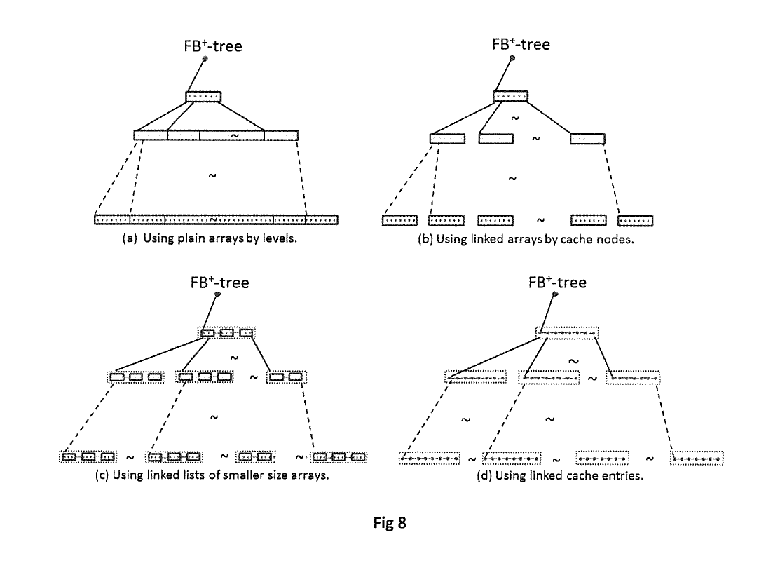

The FB⁺-tree consists of many cache nodes, which in turn consist of cache entries. Cache nodes should be seen as “virtual” nodes since they are not the same as B⁺-tree nodes and pages, which are optimized for disk storage and access. The FB⁺-tree is an in-memory structure, so cache nodes can be a lot more flexible. FIG. 8 gives some possible options for structuring the cache.

In FIG. 8(a), option (a), FB⁺-tree uses plain arrays for each level of cache nodes. Each cache node is a chunk of an array. The arrays can be of fixed size determined by the order of the B⁺-tree, i.e. the maximal number of children of an internal node in the B⁺-tree. This way we may save a little space by omitting the pointers from one node to the next, but a lot of space may be wasted due to over-allocation. The arrays can also use the size determined by the actual number of children of each node of the B⁺-tree. Of course, data insertions causing node splitting will require that the corresponding level of array be enlarged. The problem can be eased by using arrays that are slightly bigger than currently needed. This option is suitable for the applications where there are little or no data insertions, or no node splitting during the lifetime of the FB⁺-tree in main memory.

FIG. 8(b), option (b), uses linked arrays, one for each cache node. Each array can be of fixed size, minimally needed size, or slightly bigger size as discussed in option (a). This approach has more flexibility.

In FIG. 8(c), option (c), each cache node uses a list of smaller arrays. One reasonable size for each array is the size of the cache line, e.g. 512 B. Only the last array of each list may leave some space unused. The updating of each cache node will only affect one list of arrays.

FIG. 8(d), option (d), is an extreme case of (c), where each array has one element, a cache entry. In other words, in option (d), each cache node is a linked list of cache entries. Space is never over-allocated, but the list uses pointers to link the cache entries to one another. This option has the most flexibility, but uses more space to keep the pointers. When space is not an issue, this is a good way to structure the FB⁺-tree.

A cache node contains (1) information on the number of cache entries in it, (2) cache entries in one of the above forms, and (3) additional information used to facilitate implementation or optimization, as discussed below.

A cache entry of the FB⁺-tree represents a branch of B⁺-tree. Each entry holds the minimum and maximum keys of the branch, or the “branch boundaries”. The cache entry on the top of the FB⁺-tree represents the whole B⁺-tree—the total indexed key boundary. The smallest branch of the B⁺-tree is a leaf node. To avoid confusion, we do NOT call cache nodes at the bottom level of FB⁺-tree leaf nodes. Cache nodes of FB⁺-tree are all called cache nodes.

A cache entry contains information on 1) its branch range (bₘᵢₙ, bₘₐₓ), 2) a pointer (p_{c}) to its next level cache node in the FB⁺-tree, or the B⁺-tree leaf node if at the bottom, or its corresponding internal node back in the B⁺-tree in the case of creating a “shortened” FB⁺-tree (see next paragraph), 3) for the cache node structure described in option (c), each cache entry also uses a pointer (pₙ) pointing to its next cache entry in the same cache node, 4) additional information used to facilitate implementation or optimization, as discussed below.

In the most straightforward case, the height of the FB⁺-tree will be the same as that of its corresponding B⁺-tree. However, if necessary, it is flexible enough to adjust its height (and its overall size as a result) to adapt to available main memory space. The full-height FB⁺-tree works best at the cost of space, which is often not an issue for current standard computer systems or servers. There are some ways to make smaller FB⁺-trees, such as shortening the height by only using the top levels of cache nodes. In a “shortened' FB⁺-tree that works with the B⁺-tree, the bottom level cache entries have pointers pointing to a corresponding internal node in B⁺-tree. A negative value of address indicates a pointer back to the B⁺-tree. This is a straightforward approach, with the drawback of going back to B⁺-tree internal nodes.

Another approach to reduce the size of FB⁺-tree is merging every two or four cache entries (key ranges) at the bottom level to reduce the number of cache entries at that level. For example, two cache entries (<b₁, b₂>, pₓ) and (<b₃, b₄>, p_{y}) can be merged as (<b₁, b4>, pₓ, p_{y}), where p_{y} may be omitted when working with B⁺-tree leaf node level which is chained. As a result, the total size of the bottom level of the FB⁺-tree can be cut up to 50% and total FB⁺-tree size nearly in half. This is called a “narrowed” FB⁺-tree. Similarly, a FB⁺-tree can be also smaller if it refers to a B⁴⁻-tree using larger size leaf nodes.

### FB⁺-Tree Search

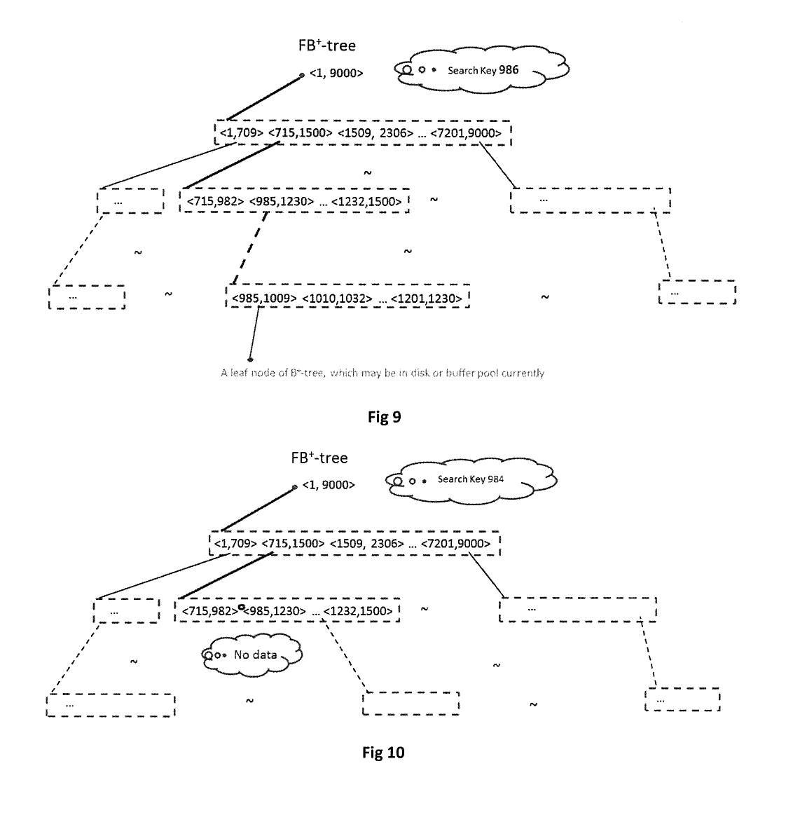

Point search with the FB⁺-tree is very fast. It starts at the root, the top cache entry, and then narrows down to finer indexing parameter (key) ranges level by level if the search key is within a key boundary. FIG. 9 gives an example of a search leading to a leaf node of the B⁺-tree. No root or any other internal node of the B⁺-tree is needed.

The FB⁺-tree search can terminate early if it determines that a key doesn't exist. FIG. 10 gives an example of a point search using a key outside (all) index parameter range(s) at some level of FB⁺-tree. The search stops as soon as possible, before ever going to next level. It would never go to the leaf node level of the B⁺-tree. On the contrary, any point search on the regular B⁺-tree must always go to the leaf level. Minimizing searching cost for non-existing keys makes great sense for complex queries that contain multiple basic searches with a lot of false keys.

With the FB⁺-tree, range searches can also be quickly processed. Typically a range search starts with a point search using its lower bound, so it is helpful to adjust it whenever possible, according to the actual valid key ranges in index parameters. Take for example a search range (99, 259), when it is compared against two close key ranges (10, 90) and (100, 202) on some level in FB⁺-tree. The lower search bound 99 should be updated as 100, since there is no valid key between 91 and 99. Upper bound can also be updated based on valid key range in index parameters to save the search cost of attempting to check whether the next neighboring key range or sibling leaf node is affected.

Like point searches, when the key range of a range search is outside of (all) index parameter range(s) at some level, the search stops right away. On the contrary, with the B⁺-tree, a range search starts with the lower key as a point search and then level-by-level move on to leaf node level. There are some slightly different ways to implement the range search procedure of the FB⁺-tree. Below are some examples:

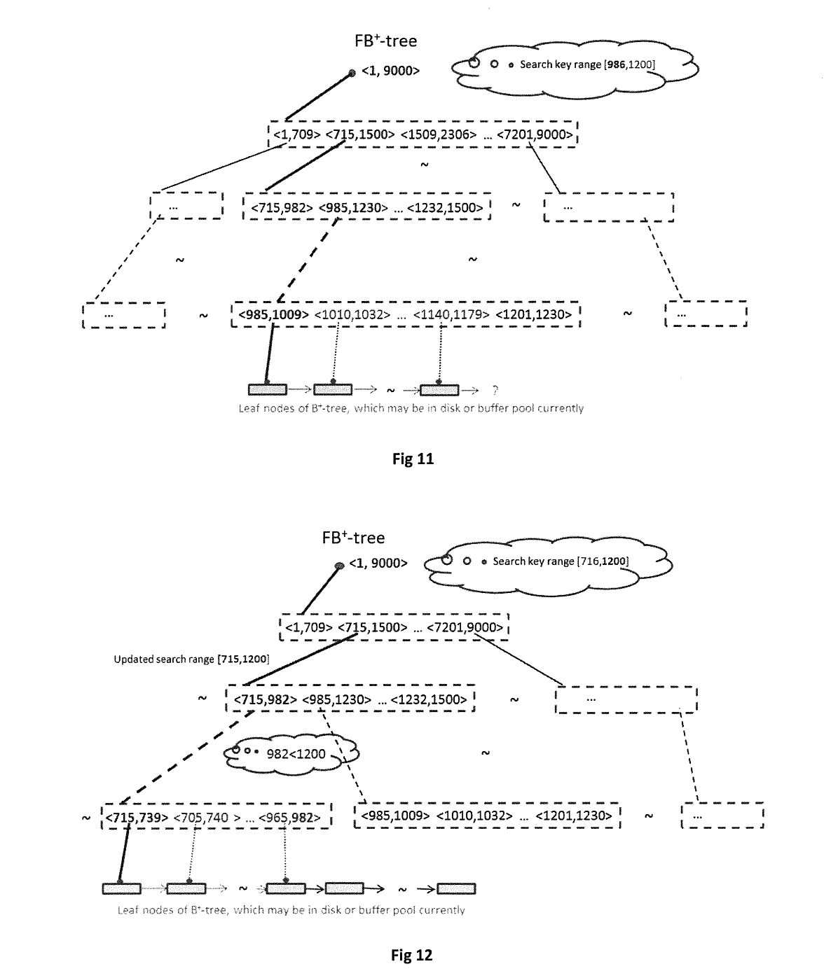

Method (a)—Start as a key search using the lower bound; update the search key range whenever necessary; unless the key range can be determined invalid early, the search will proceed to obtain the first leaf node address based on the (updated) lower bound. If more than one leaf node is needed, the search may go right along the bottom level of the FB⁺-tree for more leaf node addresses. This avoids unnecessary access of the last leaf node when the upper bound of a range search coincides with the upper bound of a cache node at the bottom of the FB⁺-tree. Alternatively, let the search move on at the leaf node level of the B⁺-tree like the regular B⁺-tree search at its bottom level. FIG. 11 gives an example of a range search. If the search covers a range larger than that of one cache node as in FIG. 12, the search may just continue by accessing more leaf node(s) at the bottom level of the B⁺-tree. Branch range(s) can be used to decide whether to keep accessing more leaf nodes outside the coverage of a cache node at the bottom of the B⁺-tree.

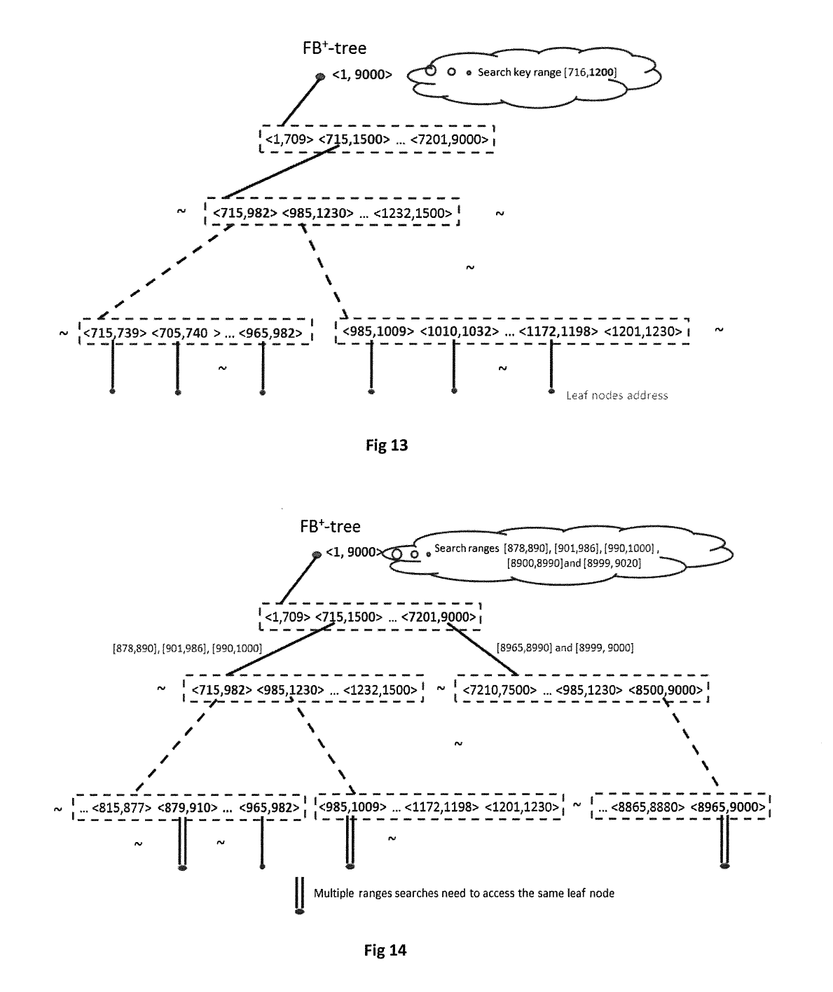

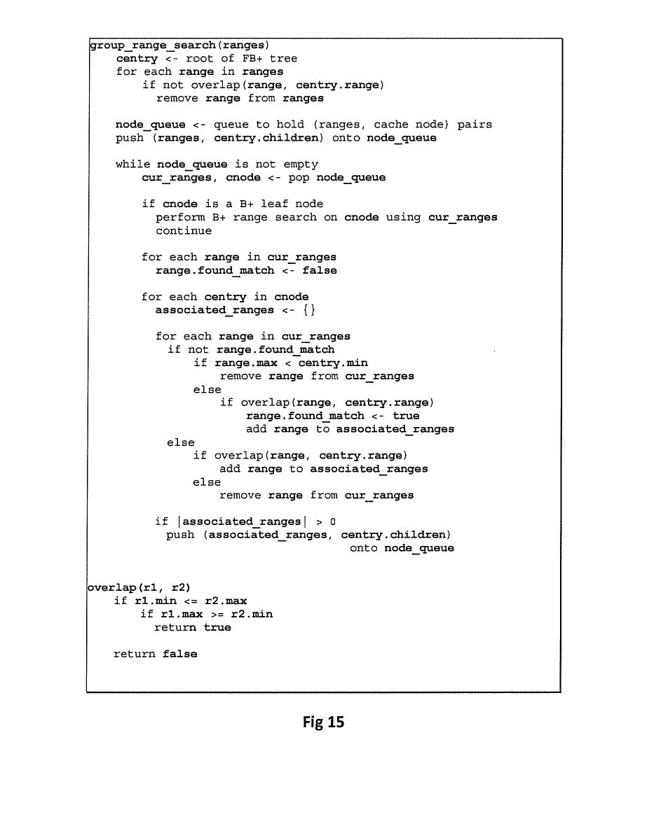

Method (b)—Given a range or group of ranges, check for all affected cache entries at every level to collect the addresses of all the necessary leaf nodes. FIG. 13 is an example that shows this type of search. This way unnecessary access of the last leaf node can be avoided. Although this approach does a few more comparisons in the FB⁺-tree than using method (a), it provides more flexibility than Method (a) and the regular B⁺-tree. For example, a complex query that contains multiple point searches and/or range searches can gather the addresses of all and only the necessary leaf nodes before actually accessing them, so that leaf node accessing cost can be minimized. The example in FIG. 14 shows how leaf node accesses can be saved for a group of range searches of a complex query if they are processed together on FB⁺-tree before accessing any leaf nodes. The algorithm for this “one-pass” multi-range search is given in FIG. 15.

Methods (a) and (b) don't have much cost difference for a single range search. The only possible disk access is for the leaf node(s), if they are not currently in memory (e.g. the buffer pool). A FB⁺-tree (except the shortened version) never needs to access internal nodes of the B⁺-tree for searching, so the buffer pool won't be used for internal nodes for search processing. Potentially, there can be more leaf nodes staying in the buffer pool during database operation. That means a higher hit rate in general. Method (b) has more advantages for range searches, when many are processed together.

### Building a FB⁺-Tree

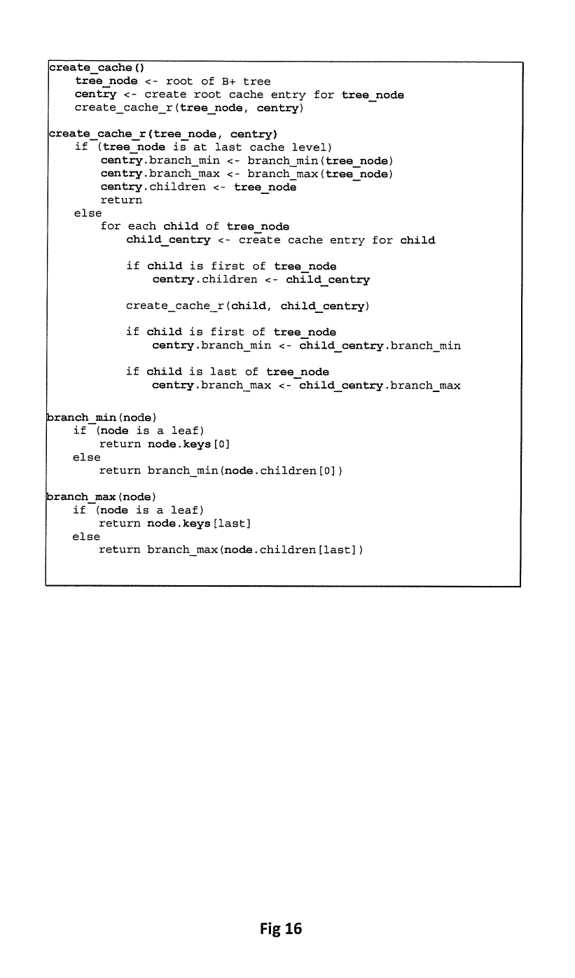

An FB⁺-tree can be built with one pass on the B⁺-tree. The algorithm is shown in FIG. 16. This description of the algorithm is meant to be at a high enough level to accommodate all possible cache structures, although it may represent the structure option of (d) best. Here, the children variable of each cache entry is set to its first child cache entry. In array-based approaches, children would point to an array of children, not to a single entry. When at the last level of the cache, children is made to point to an actual leaf node of the B⁺-tree. (Some adjustment is needed for shortened or narrowed versions.) While the FB⁺-tree is an in-memory structure, it can certainly be saved as a record and quickly brought back to main memory for next time, as long as it is still up-to-date.

When there is an insertion or deletion on the B⁺-tree, updates on the FB⁺-tree are needed only when 1) a branch range (either bₘᵢₙ or bₘₐₓ) is changed or 2) there is node splitting or merging, which involves branch range changing.

For insertion and deletion operations in the FB⁺-tree, a search path will be traced to the target key through both the B⁺- and FB⁺-trees. After the appropriate operations are performed on the B⁺-tree, the FB⁺-tree will be checked to make sure that it still accurately reflects the state of the B⁺-tree.

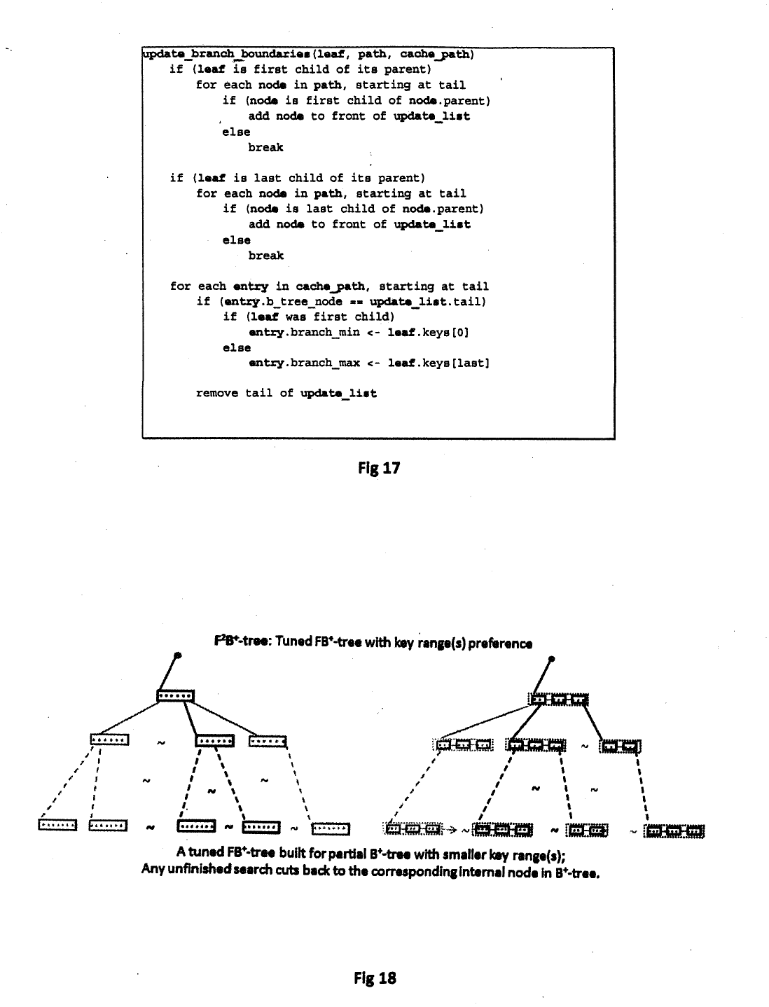

When performing insertion and deletion operations, an algorithm for calculating new branch boundaries will be employed. Given the last leaf in a search, a B⁺-tree search path and a cache search path, all necessary branch boundaries can be updated using the algorithm shown in FIG. 17.

For insertion, when the specified key is inserted into the appropriate leaf in the B⁺-tree, a branch boundary update algorithm is used to make sure the FB⁺-tree still reflects the B⁺-tree. Even if the leaf node has to split, the above algorithm is all that is needed to work things out. The algorithm is called twice, once for the old leaf, and once for the new.

If internal node splits are necessary, new cache entries are added to the FB⁺-tree. The specific implementation depends on the data structure(s) chosen earlier. The branch boundaries for new cache entries can easily be calculated using the aforementioned branch_min and branch_max algorithms. It is easy to see that this same update_branch_boundaries algorithm is also sufficient for deletions.

### Tuned FB⁺-Trees

The FB⁺-tree is designed to speed up searches that could be processed on a B⁺-tree. Further optimizations may be used as described below. Two variations of the FB⁺-tree are presented next, which are called F²B⁺-tree and F³B⁺-tree, to show what the strategies are and how they may be used. In fact, strategies of each one can be used together to tune the FB⁺-tree for better performance. Each one will be explained separately.

### The F²B⁺-Tree

Very often a user's interest is mostly or only in a small portion of data. While a B⁺-tree indexes a whole data set, that doesn't mean a full FB⁺-tree needs to be built in main memory, nor does it mean that the indexes need to be the same for all users, who may have different interests. In the case where each user has his/her own terminal, personal computer or portable device, a personalized FB⁺-tree created locally in main memory may greatly reduce response time, especially if the interested data have local copies. In the case where there are recognizable types/groups of users with similar interests, multiple smaller copies of different versions of partial FB⁺-trees created on the server can help reduce response time and yet improve availability and security. To differentiate from the original full FB⁺-tree, a partial FB⁺-tree is called an F²B⁺-tree. It is an express version of FB⁺-tree for the subset of objects of a predetermined key ranges. FIG. 18 illustrates two examples of F²B⁺-trees that index a smaller key range(s). An unfinished search on a F²B⁺-tree cuts back to the corresponding internal node in the B⁺-tree, so that the search can continue normally in the B⁺-tree. If there is a full FB⁺-tree also available (e.g. on a server), the unfinished searches can continue on the full FB⁺-tree. It is especially feasible in cases where the searches are processed on main server(s) which have a large main memory with multiple versions of FB⁺-trees and F²B⁺-trees created.

The F²B⁺-tree can also be combined with some ideas from artificial intelligence in order to predict future queries. Small F²B⁺-tree(s) might be dynamically built on-the-fly to prepare for future queries by narrowing the scope of the index.

### The F³B⁺-Tree

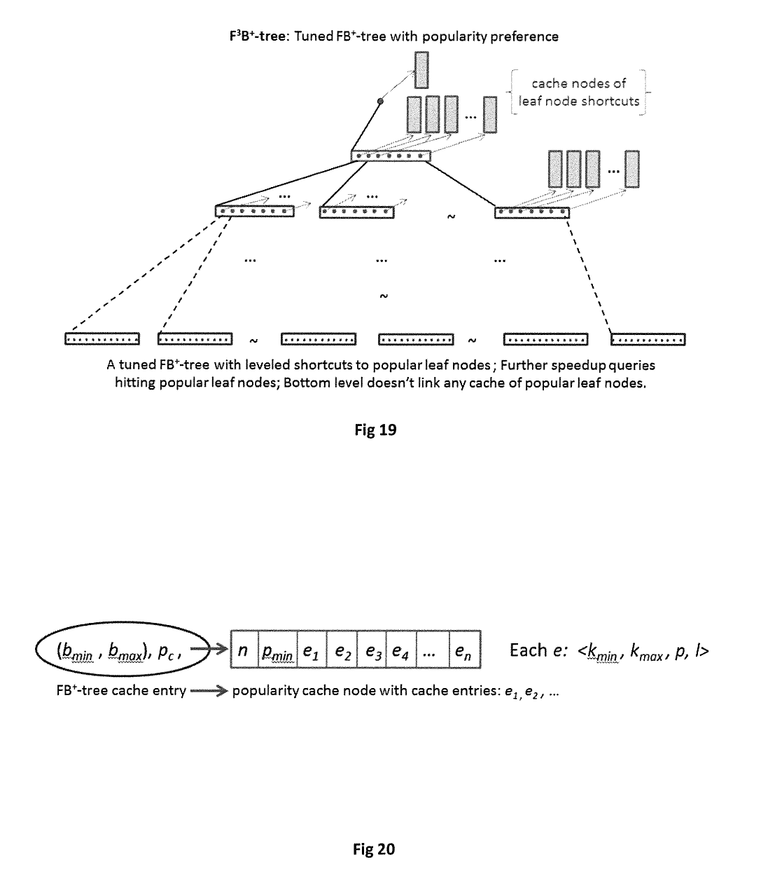

Another way to tune the FB⁺-tree for higher searching speed is by exploiting popularity characteristics—to be more specific, the B⁺-tree leaf nodes' popularities. The idea is that some records are accessed more (possibly much more) than others, so, if the popular leaf nodes can be accessed more quickly, overall FB⁺-tree performance can be improved. FIG. 19 illustrates the idea of the F³B⁺-tree, which is a tuned FB⁺-tree adapted with popularity preference. It indeed works best for the shortened FB⁺-trees, since it saves disk accesses by using ‘shortcuts’. For this reason, F³B⁺-tree is usually shortened; however, for simplicity of explanation, the idea is explained using the regular FB⁺-tree as below.

In the F³B⁺-tree, beside the original cache nodes of the FB⁺-tree, another type of cache node, called a popularity cache node, is used to hold shortcuts to popular leaf nodes. Each cache entry in the original FB⁺-tree is linked to a popularity cache node. FIG. 20 shows the detailed structure of a popularity cache node and the cache entry that links to it.

A popularity cache node contains the number of entries (n), a pointer to the least popular entry (pₘᵢₙ), and a series of popularity cache entries (e₁, . . . , eₙ). An individual popularity cache entry has low and high keys of the leaf it points to (kₘᵢₙ, . . . , kₘₐₓ), the leaf's popularity score (p), and a pointer to the leaf (l). Just to emphasize, shortcuts to leaf nodes are cached, not leaf nodes themselves. The popularity score may not be needed, depending on implementation and needs to adjust levels of caching. When popularity cache nodes are built up, the more popular leaf nodes get their shortcuts cached closer to the top level, which is the root of the tree structure.

As a search comes in, whenever it reaches a cache entry of the FB⁺-tree, it checks its popularity cache node first. If the key is within the key range of popular leaf nodes, a shortcut is taken directly. With the frame structure of the FB⁺-tree, each popularity cache node only caches the shortcuts of the leaf nodes that are within the range of the cache entry branch. The more popular a leaf node, the closer its shortcuts are cached to the top of the tree structure. The cache is dynamically reordered to ensure that this condition holds as much as possible.

There are different ways to record the popularity of leaf nodes. One straightforward way is to maintain popularity scores for both cached leaf nodes and uncached leaf nodes. Each leaf node stores an integer that counts the number of hits. Maintaining this value involves writing the new value back to the B⁺-tree after each search. It is certainly too costly if each read, a leaf node hit, involves a write. The problem can be alleviated by delaying the changes until the system is idle. In fact, the popularity cache should also only update itself when the system is idle to ensure that the popular leaves can be accessed most quickly.

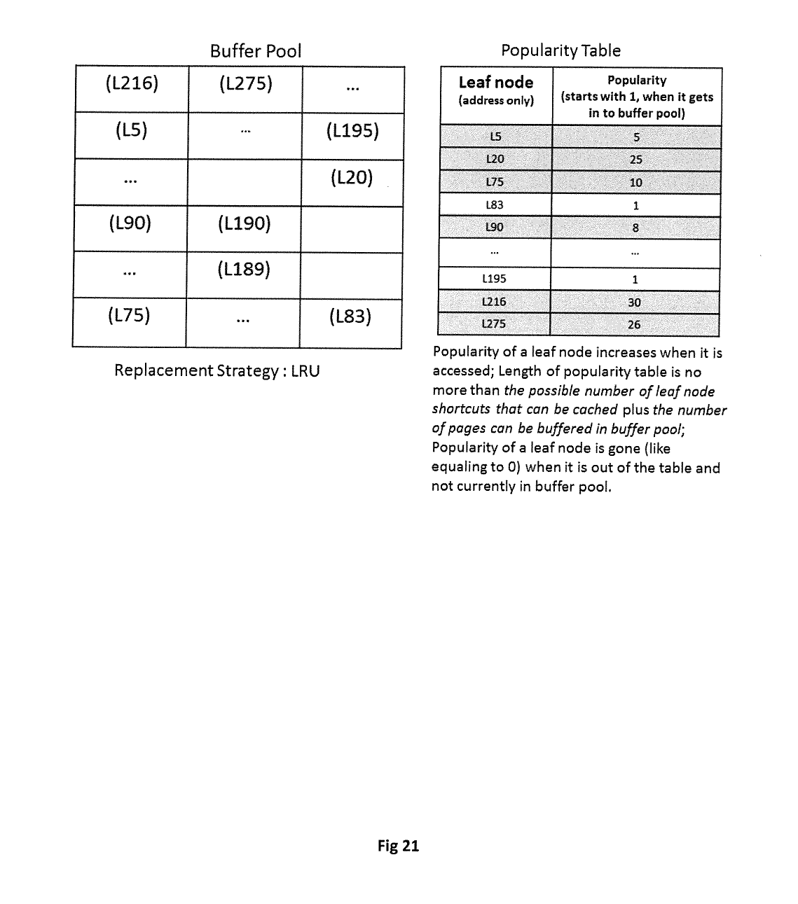

Another more appealing way is to maintain popularity information in main memory, separate from the B⁺-tree structure. Different methods can be used. Here a method is presented that makes use of the existing database buffer pool. FIG. 21 shows a small example comparing a Popularity Table to a Buffer Pool and their relationship. The Popularity Table can be sorted by leaf node IDs (addresses). It can also be unsorted and assisted with a small index/hash table. The point is that a leaf node ID should be found quickly whenever it is needed.

There are several ways to build up popularity cache nodes. For instance, strategy (a) is to gradually build up as the popularity table grows and changes from the beginning of system operation. This requires leaf node popularity scores to be maintained in popularity cache entries, since popularities change during the process and entries are expected to move a lot among the popularity cache nodes. This means higher updating cost. As mentioned earlier, the popularity cache should only update itself when the system is idle to ensure that the popular leaves can be accessed most quickly.

Another way, strategy (b), is to start to build only after the system operates for a while, when the popularity table has some popularity information, but not necessarily to wait for it to mature. It means there will be movements of popularity cache entries among the popularity cache nodes, but not as much as the beginning of strategy (a). In this case, there can be a loose requirement of leaf node popularities to be maintained in cache entries. A pointer (pₘᵢₙ) to the popularity cache entry with lowest popularity will be helpful enough to test for a popularity cache entry replacement. This method however requires a check of the popularity table in order to update pₘᵢₙ. Since strategy (b) is not expected to have too many popularity cache node updates, the cost might be endurable.

Another way, strategy (c), to reduce more updating costs is to generate popularity cache nodes after the popularity table is stabilized and the popularity distribution scale is stable, so that cache entries' positions in cache nodes don't need changes and can still produce good performance. In this case, popularity scores do not need to be kept in cache nodes. If occasional updates are desired, keep pₘᵢₙ in each popularity cache node; otherwise they can be omitted.

When a search is performed on the F³B⁺-tree, details are tracked, such as whether the target leaf node is cached, and whether there is empty space for a new popularity cache entry on the way down. If the leaf arrived at is already cached in the tree (i.e. a shortcut was taken to get there), the popularity value is updated in the popularity table and the popularity cache entry. That is a simple and fast case. If the leaf is not cached in the tree, a determination is made to see if any space was encountered on the way down. If an empty slot is found, a new popularity cache entry is created for the leaf and it is placed in the empty space. If no empty space was found during the search, attention is drawn to the last cache entry encountered during our search. If one of the cached leaves in its popularity cache node has a lower popularity than the one just searched for, the leaf is cached in the popularity cache node and the less popular entry is discarded.

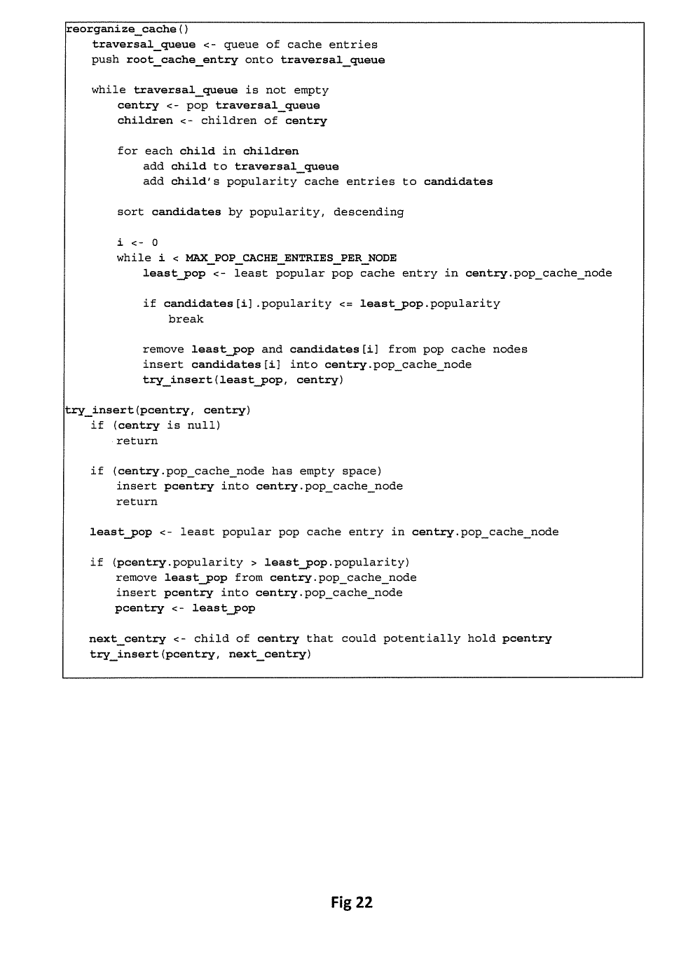

By this process, popularities are updated and new leaves are added to the cache. It is the job of the cache reorganization algorithm (see FIG. 22) to keep the popularity cache entries in the right places. The most popular leaf nodes get shortcuts at the top, while less popular leaf nodes have shortcuts further down the tree. The cache reorganization algorithm runs when the system is not busy servicing other requests. Popularity nodes should be used for the top levels (2 is a good number) of the tree structure and not for the bottom level as placing popularity nodes at the bottom level will not increase the search speed.

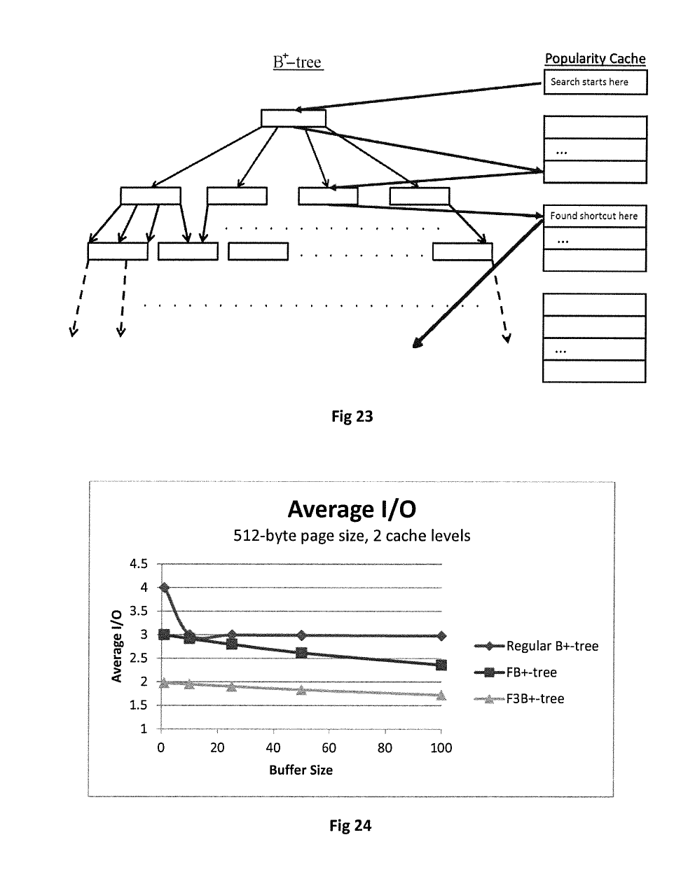

Popularity nodes could also be applied to the B⁺-tree directly, even if there is no FB⁺-tree. For example, a certain number of nodes in the B⁺-tree can be given their own cache nodes, which are simple structures in main memory where shortcuts to popular leaf nodes are stored. To cut down on search time on the B⁺-tree, at each level, a search checks a corresponding cache node for shortcuts before going further down the B⁺-tree if no short cut is found. This is illustrated in FIG. 23.

### Memory Consumption

The FB⁺-tree is a light indexing structure compared to the whole B⁺-tree. Finding the total memory consumption of the cache is simple since the structures so closely resemble the normal B⁺-tree. The size of an FB⁺-tree cache is directly related to the total number of nodes of its corresponding B⁺-tree. If a structure like option (a) in FIG. 8(a) is chosen, then arrays will exist at each cached level that can accommodate a cache entry for each possible node in that level in the B⁺-tree. The size of a cache entry s_{ce} in the FB⁺-tree is constant:

s_{ce}=2*sizeof(keytype)+sizeof(pointer)

Given the fan out f of the B⁺-tree, the total memory consumption m of the FB⁺-tree cache for structure option (a) is

$$m = {\sum }_{l = 0}^{L - 1} {f}^{l} {s}_{ce}$$

where L is the number of levels cached. In this case, fan out is a maximum, so that the FB⁺-tree is ready to hold all possible cache entries.

Other different approaches to structure the Fattree cache are shown in FIG. 8(b, c, d). There are some variances in space cost, because of different space pre-allocation requirements, potentially wasted space, and additional pointers required to form links. Different approaches may work better in different situations.

Let's look at a situation where it is desired to cache 3 levels of a B⁺-tree with a (maximum) fan out of 300 and a cache entry size of 12 bytes for FB⁺-tree structure option (a) and 16 bytes for option (d). If the (shortened) FB⁺-tree is 2 levels tall, then with option (a), then the memory is used up to hold

n=93 ₗ₌₀¹300^{l}=1+300=301 cache entries≈3.5 KB

If the FB⁺-tree is 3 levels tall, then with option (a), the memory is used up to hold

n=Σₗ₌₀²300^{l}=1+300+90000=90301 cache entries≈1.0 MB

Option (d) can hold 67725 cache entries with that much space, or 75% the number of entries option (a) can hold. It is important to know how much the B⁺-tree fills its levels. If more than 75% of the tree's maximum number of nodes given the number of levels is used, then it is beneficial to use option (a). If less is used, space will be saved by using option (d). Normally, a B⁺-tree fills 60˜70% of its levels.

Because B⁺-trees, or parts of B⁺-trees, are sometimes placed directly in main memory for a speed increase, it is useful to compare the size requirements of the B⁺and FB⁺-trees. The relation between these two trees is that a B⁺-tree node corresponds to a FB⁺-tree cache entry. As shown above, the FB⁺-tree cache entry is a constant 12 or 16 bytes on most systems, depending on which structure option used and what kind of data is being stored. The size of a B⁺-tree node depends on a few factors as discussed in the examples below.

B⁺-tree is designed for disk storage, so node size is related to page size. Assume a B⁺-tree with each node size 4 KB, 4-byte keys, 8-byte pointers, and each internal node having 240 children on average, which is pretty normal (around 70%) tree space utilization. So, on average, each internal node has 239 keys and 240 pointers. Each leaf node can be expected to have about 239 keys and 240 pointers, include the one extra to point to the next leaf node. The size of a 4-level B⁺-tree is

s_{btree}=4 KB*(1+240+240²)+4 KB*(240³)≈53 GB
Its top 3 levels (all internal nodes) use about 226 MB space.

The size of the corresponding 4-level FB -tree is

s_{fbtree}=s_{ce}(1+240+240²+240³)≈212 MB

With 16-byte cache entries.

FB⁺-tree space can be reduced by using its ‘shortened’ or ‘narrowed’ version. Using the same hypothetical B⁺-tree, the 2- and 3-level ‘shortened’ FB⁺-trees are 4.7 KB and 1.4 MB in size respectively. The ‘narrowed’ 4-level FB⁺-tree has size around 106 MB or 159 MB depending on how the detailed cache entry structure on the bottom level is adjusted.

The size of F²B⁺-tree varies more. The more ranges chosen not to be cached, the less space you need. The space requirement for the F³B⁺-tree is greater than FB⁺-tree of the same height since the cache has to hold popularity information. However, since the F³B⁺-tree is usually shortened, space most likely is not a concern.

There is no mandatory size s_{pcn} for a popularity cache node—the user can select this as he or she sees fit, and the allowed number of popularity cache entries per node will be adjusted accordingly. However, the regular cache entries themselves will each have to add an extra pointer to address the new popularity cache nodes. Even so, since the popularity cache nodes will be considerably larger than any one cache entry, the user-selected s_{pcn} value will have the greatest influence on the memory consumption of the F³B⁺-tree.

### CPU Computation Cost

One way of analyzing the performance of these structures is to inspect the number of comparisons each performs. By comparison, we mean that two numbers are compared to see if the first is less than, equal to, or greater than the other. This is a good indicator of how much the structure is using the CPU.

Comparisons in the regular B⁺-tree primarily consist of finding the right childtodescend to. In the worst case, this would involve making f-1 comparisons at each internal level of the tree, where f is the average fan out of internal nodes in the tree. Once a leaf is reached, the worst case would involve searching through every key. (In fair comparison, assume both FB⁺-tree and B⁺-tree use sequential search within one node, since any small optimization can be used on both techniques.)

Movement through the FB⁺-tree is in a similar fashion. The main difference is that a determination is made to see if there is a fit between branch boundaries. The amount of comparisons performed is slightly higher than that of B⁺-tree, but it does not need to be doubled in order to move down a level. The cost is offset, of course, by the possibility of abandoning a search early when it is determined that the target key does not exist within any branch boundary in a given cache node, and hence does not exist at all.

Imagine a B⁺-tree with 4 levels and an average number of children of each internal node is 240. At each node, using average fan out, the worst case number of comparisons is 239, if using a simple linear search strategy. At the leaf level, every key, roughly 239, must be checked. This gives a total of 239+239+239+239=956 comparisons.

In the corresponding full-height 4-level FB⁺-tree, keys are not used but rather branch boundaries. The average number of pairs of branch boundaries for each child at each cache node is 240. Finding out whether a search key is within a single pair of branch boundaries requires two comparisons: for example, a determination is made by checking whether the search key is smaller than or equal to the maximum, and if it is smaller, checking whether it is greater than or equal to the minimum. However, with a list of sorted ranges to check, in the worst case, it needs just 241 comparisons per cache node. For example, check the key against the maximums first; if it becomes equal to or less than a maximum, check with the minimum of the current range; if it larger than or equal to the minimum, a relevant range is found. Looking through the leaf node costs the same as in the B⁺-tree search, so the total number of comparisons for this FB⁺-tree in the worst case is 2+241+241+241=725. Adding the comparisons in the leaf node (of B⁺-tree) possibly accessed to find the actual object (address), the total cost in worst case is 725+239=964 comparison.

In the corresponding shortened 3-level FB⁺-tree, which means the possibility of going back to B⁺-tree and checking on its lowest two levels, the total number of comparisons in the worst case is 2+241+241+239+239=962. So, B⁺-tree and FB⁺-tree of any height has similar computing cost to find an existing object.

The comparison analysis is similar for the F²B⁺-tree, since the possibility of having to return to the actual B⁺-tree to finish a search doesn't cost extra. It is not difficult to see that the F³B⁺-tree could do some more comparisons since it looks through popularity cache entries as well as regular cache entries in worst case. Again, the catch is that there is the possibility of an early stop: a leaf node shortcut could be found at any time, thus eliminating the need for many comparisons within the cache. At last, the benefit of doing fewer comparisons is miniscule compared to the drawback of having to go to the disk.

### Disk Access

When disk accesses are involved, it is often possible to measure the effectiveness of an invention like this primarily by its disk usage patterns. If searches rely less on the disk than the regular B⁺-tree, they will outperform the B⁺-tree in many situations. The FB⁺-tree is designed to reside in main memory, so it requires no IOs. Aside from the shortened version, accessing the leaf nodes (of B⁺-tree) is the only possible step that requires IO cost. When a search can be terminated earlier, there will be no IO needed at all.

First consider a comparison between the regular B⁺-tree, shortened FB⁺-tree, and the shortened F³B⁺-tree. (The narrowed FB⁺-tree and the F²B⁺-tree are not considered here because their main goal is to minimize memory consumption, not to be faster than their FB⁺counterparts. The full-height FB⁺-tree is not considered because it requires no IO on itself.) For this comparison, consider a B⁺-tree with a 512-byte page (node) size and 2,000,000 records. We'll look at a shortened 2-level FB⁺-tree and a shortened 2-level F³B⁺-tree. For the F³B⁺-tree, 512-byte popularity cache nodes are used. The tests assumed that half of the queries were considered “popular”. To avoid IOs of repeated disk accesses for the recently fetched pages, a simple LRU buffer is used alongside each indexing structure. We thought it would be appropriate to use such a buffer since they are very common in real systems. The graph is shown in FIG. 24.

The first thing to notice is that both cache structures outperformed the regular B⁺-tree. Also note that while the regular B⁺-tree performed about the same for every buffer size past 20, the 2-level FB⁺-tree structures performed better and better as buffer size went up. Therefore the 2-level FB⁺-tree structures are able to take advantage of the extra resources they are given.

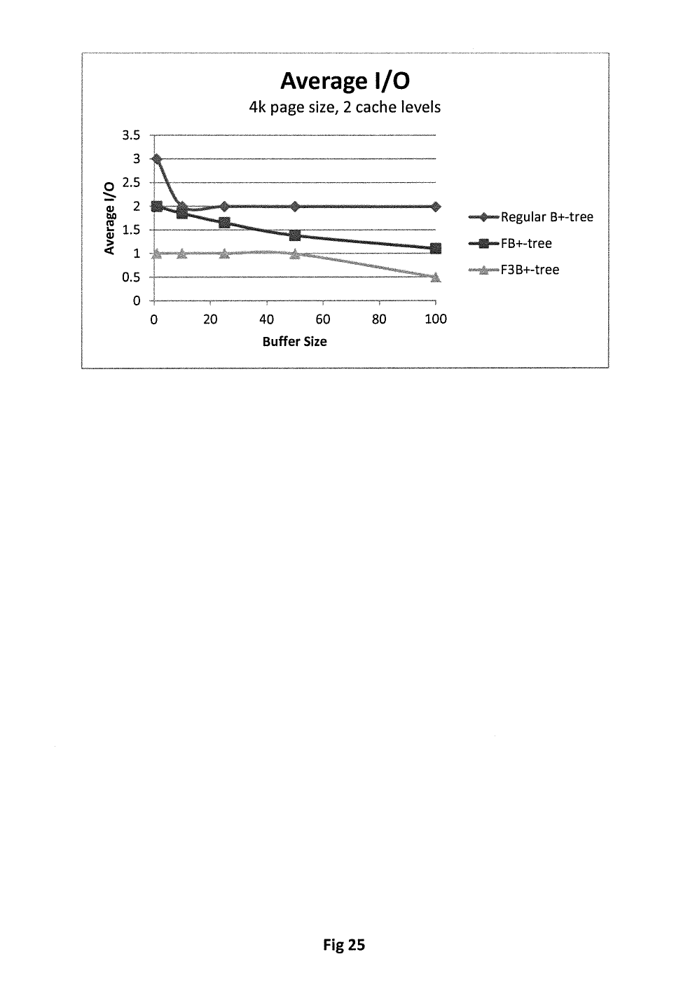

Also consider how the performance of the F³B⁺-tree changes when more than half the queries are “popular”. To illustrate this, we run a test of only “popular” searches. FIG. 25 shows this test with a page size equal to 4 KB. A 2-level F³B⁺-tree with 2 levels of 4 KB popularity cache nodes is used.

The results in FIGS. 24 and 25 show that all of the structures are performing better thanks to the increased page size. The graphs for the B⁺-tree and 2-level FB⁺-tree look about the same as they did before, but the 2-level F³B⁺-tree looks a little different and stays at a local minimum until a high buffer size allows it to break down below one average disk read. With the right combination of popular queries and appropriate tree configuration, the 2-level F³B⁴-tree is quite capable of regularly performing searches without going to disk at all.

In both of these examples, the 2-level F³B⁺-tree outperforms the 2-level FB⁺-tree. Intuitively, this is in part because the cache has only been two levels deep. Where the 2-level F³B⁺-tree has a chance of finding a shortcut early and skipping over large portions of the tree, the 2-level FB⁺-tree must always go to the B⁺-tree. Consequently, the performance of each tree begins to converge when the whole tree becomes cached, because neither tree has to read nodes from disk on the way down. In this case, the full-height FB⁺-tree might be the smarter choice because it avoids the overhead of managing popularity.

### CONCLUSION

The present invention provides a new indexing technique based on multi-level key ranges. The technique can be easily adopted into existing systems with B⁺-tree, ISAM or data list of sortable keys. The FB⁺-tree is a proposed example of using this technique referring to B⁺-tree. It is an in-memory structure that allows finding B⁺-tree leaf nodes very fast. The FB⁺-tree can be easily built from any B⁺-tree when needed; and it can be saved and loaded as needed. The FB⁺-tree handles updates gracefully.

The present invention also introduced two FB⁺-tree enhancements, the F²B⁺-tree and the F³B⁺-tree. The F²B⁺-tree enhances the FB⁺-tree by allowing us to only cache pieces of index of the key ranges that interest individual users, special group of users, or particular queries. This way, the cache's memory requirement can be also reduced. If a search needs to find a record that isn't in the key ranges cached, it goes back to the original B⁺-tree and continues the search from there. In addition, the F²B⁺-tree can be used in a strategy that attempts to guess future queries based on previous ones and build partial indexes accordingly.

Finally, the F³B⁺-tree is a smarter version of the FB⁺-tree that is aware of leaf node popularity. The F³B⁺-tree answers the question, “What is being searched for most?” and uses that information to make future searches better. Shortcuts to popular leaf nodes are kept in the cache, and these shortcuts can end the search faster for popular queries. As popularities change so does the F³B⁺-tree; cache shortcuts are dynamically moved throughout the cache during operation so that the most popular shortcuts are on top.

The FB⁺-tree looks to exploit the main memories of today's computers without being too space-intensive. It is easy to implement as it can make use of the regular B⁺-trees instead of completely replacing everything. It specially and efficiently supports basic searches. The FB⁺-tree is also very flexible. It can be shortened or narrowed to fit small memory. Its enhancement strategies, such as F²B⁺-tree and F³B⁺-tree, can make the indexing smarter. Further, different strategies can be used together. For an extreme example, a turned indexing structure has part of sub-tree like shortened FB⁺-tree (for key ranges outside current interest), part of sub-tree like F²B⁺-tree (for key ranges of current interest) and part of sub-tree like F³B⁺-tree (for most popular leaf nodes). In short, with many ways to tune the tree, great performance is easy to achieve in a wide variety of situations. This structure improves database performance in many settings.

While the present invention has been described in conjunction with specific embodiments, those of normal skill in the art will appreciate the modifications and variations that can be made without departing from the scope and the spirit of the present invention. Such modifications and variations are envisioned to be within the scope of the appended claims.

1. A search method implemented on a computer for indexing a plurality of objects stored in a data storage system and searching for specific stored objects included within the plurality of stored objects, the method comprising:
creating and storing a plurality of index parameters for the plurality of stored objects with the plurality of index parameters being stored in a plurality of cache nodes, each cache node containing more than one said index parameter and all said index parameters stored in each cache node being organized in a predetermined order;
creating a multi-level hierarchy among the cache nodes wherein index parameters stored in the cache node at the highest level in the hierarchy defines a total range of said stored objects and said index parameters stored in the cache nodes at lower levels in the hierarchy define specific subsets of the total range of said stored objects; and
processing a search using a search key for said specific stored objects by analyzing the index parameters stored in the cache node hierarchy.

2. A search method in accordance with claim 1 wherein each said cache node includes pointers to cache nodes at the next lower level in the hierarchy and wherein a search for specific objects utilizes a pointer in a first cache node to continue the search in a cache node(s) at a lower level in the hierarchy than the first cache node.

3. A search method in accordance with claim 2 wherein a search for specific stored objects proceeds from a cache node at the highest level in the hierarchy to cache node(s) at a lower level in the hierarchy until the locations of specific stored objects are detected at the lowest level in the hierarchy or determined to not reside in the hierarchy.

4. A search method in accordance with claim 2 wherein each cache node contains a list of index parameters and the analysis of index parameters during a search for specific stored objects includes determining whether the specific stored objects are included within the range(s) of index parameters contained within a cache node.

5. A search method in accordance with claim 4 wherein a search for specific stored objects proceeds from a first cache node to cache node(s) at a lower level in the hierarchy than the first cache node if the specific stored objects being sought are within a range(s) of the index parameters contained in the first cache node.

6. A search method in accordance with claim 1 wherein each said cache node containing more than one index parameter does not contain a root.

7. A search method in accordance with claim 1 wherein a search moves to a new level in the hierarchy when the search key is within a predetermined range of index parameters.

8. A search method in accordance with claim 1 wherein a search determines that a specific stored object being sought does not reside in the data storage system as soon as it is determined that a predetermined search key is not found in any of the plurality of index parameters.

9. A search method implemented on a computer for indexing a plurality of objects stored in a data storage system and for searching for specific stored objects included within the plurality of stored objects, the method comprising:
creating and storing a plurality of index parameters for the plurality of stored objects, with the plurality of index parameters being stored in a plurality of cache nodes and where each cache node contains more than one said index parameter, and all said index parameters stored in each cache node are organized in a predetermined order;
selecting a subset of index parameters and caching said subset as an express index to support searches for specific stored objects within a predetermined subset of stored objects;
implementing a search for specific stored objects from the predetermined subset of stored objects by analyzing the index parameters in the selected subset of index parameters; and
continuing the search for specific stored objects by analyzing more index parameters than the selected subset of index parameters if the location of a specific stored object is not detected by analyzing the selected subset of index parameters and also is determined not to reside in the hierarchy.

10. A search method in accordance with claim 9 wherein a multi-level hierarchy is created among the cache nodes containing a list of index parameters, the range of index parameters in a first cache node being greater than the range(s) of index parameters in the cache node(s) at a lower level in the hierarchy than the first cache node.

11. A search method in accordance with claim 10 wherein the search for specific stored objects proceeds from a first cache node to the next level within the multi-level hierarchy and within or outside the selected index parameters in response to pointer(s) in said first cache, unless early termination is determined.

12. A search method in accordance with claim 11 wherein the search for specific stored objects proceeds from the one cache node to the cache node(s) in the next level in the hierarchy of the selected index parameters, if there are specific stored objects identified by a range of index parameters in the current cache node and there are corresponding cache node(s) at the next level in the hierarchy of the selected index parameters.

13. A search method in accordance with claim 11 wherein the search for specific stored objects proceeds from one cache node to a different level in the hierarchy of the selected index parameters, if there are specific stored objects within any range(s) of indexing parameters in the current cache node, but outside the selected index hierarchy.

14. A search method implemented on a computer for indexing a plurality of objects stored in a data storage system and searching for specific stored objects included within the plurality of stored objects, the method comprising:
creating and storing a plurality of index parameters for the plurality of stored objects with the plurality of index parameters being stored in a plurality of cache nodes;
identifying the cache nodes included within the plurality of cache nodes that contain index parameters used most often in the searches for specific stored objects;
implementing a search for specific stored objects by first analyzing the index parameters in the cache nodes that are used most often in searching for specific stored objects; and
continuing the search for the specific stored objects by analyzing more index parameters than the index parameters used most often if the search using only the index parameters used most often fails to detect the location of the specific stored objects.

15. A search method in accordance with claim 14 wherein a multi-level hierarchy is created among the cache nodes and the cache nodes containing the index parameters used most often are specially cached closer to the highest level in the multi-level hierarchy than cache nodes containing index parameters used less often.

16. A search method in accordance with claim 15 wherein cache nodes containing index parameters used most often are linked to an entry cache node at which a search for specific stored objects is commenced and upon commencement of a search for specific stored objects, the cache node containing index parameters used most often is checked first upon the commencement of the search.
